(19) United States
(12) Patent Application Publication
(10) Pub. No.: US 2003/0041262 A1
(43) Pub. Date: Feb. 27, 2003

(54) Content protection system

(76) Inventor: Masashi Kon, Kanagawa (JP)

Correspondence Address: Bell, Boyd & Lloyd LLC, P.O. Box 1135, Chicago, IL, 60690, US

(21) Appl. No.: 10/226,516

(22) Filed: Aug. 22, 2002

(30) Foreign Application Priority Data
Aug. 23, 2001 (JP) P2001-252619

(51) Int. Cl. H04L 9/00

(52) U.S. Cl. 713/200; 713/173; 380/277

(57) ABSTRACT

A content distributing server refers to user authenticating open key certificates transmitted from user equipment to authenticate users. Further, it inserts an electronic watermark into a content in which any electronic watermark has not yet been inserted. A check server checks contents stocked in the content distributing servers, and if unjustness is detected, it requests an authentication organization server to rescind the user authenticating open key certificate of the content distributing server. The authentication organization server issues the open key certificates for authentication of users and content distributing servers and a rescission list in which only rescinded open key certificates are described. Further, the rescission list is renewed on the basis of a notification from the check server.

### BACKGROUND OF THE INVENTION

The present invention relates to a content protection system, and particularly to a content protection system including an authentication organization for comprehensively managing authentication systems of users and a check server for specially checking contents having electronic watermarks inserted therein such that the contents can be comprehensively protected.

A conventional content protection system has practically used such a technique that when a content required to be protected is transmitted from a content distributing server to an apparatus owned by a user, the content distributing server authenticates the user concerned and inserts an electronic watermark into the content. The content is then allowed to be reproduced only by equipment owned by a regularly-contracted user (i.e., a subscriber) and is prohibited from being reproduced by equipment owned by a non-contracted user (i.e., non-subscriber).

A unique authentication system has been independently adopted by a number of content distributing servers for the authentication systems of users. Further, the electronic watermark is independently inserted by a content distributing server or by an original content server which supplies an original content to a content distributing server to request the content distributing server to distribute the content.

As described above, the conventional content protection system has adopted a unique authentication system for a number of content distributing servers. Therefore, a user must use each different type of open key for authentication by every content distributing server, and this is inconvenient for users.

Further, when a user reproduces a content downloaded into his/her equipment, this system is inconvenient because a method of removing an electronic watermark inserted in the content is different for every content distributing server supplying contents.

Still further, the situation where an electronic watermark, inserted in a content, which a content distributing server is requesting for distribution from an original content server, is removed by the content distributing server without the prior consent of the original content server, or replaced by a unique electronic watermark of the content distributing server without the prior consent of the original content server cannot be prevented.

When the content distributing server independently prescribes the specification of an electronic watermark to be inserted into a content and makes the original content comply with the specification, contamination of an electronic watermark other than the prescribed specification in a content for which the distribution is requested from the original content server cannot be prevented.

### SUMMARY OF THE INVENTION

An object of the present invention is, therefore, to provide a content protection system in which authentication systems are consolidated among users and servers and the management of contents having electronic watermarks inserted therein is unified so that the contents can be comprehensively protected.

In order to attain the above object, according to an embodiment of the present invention, there is provided a content protection system for checking contents which are accumulated in a content distributing server and will be distributed to users I equipment in response to requests from users, thereby preventing the contents from unjustly outflowing. The system includes at least one content distributing server including a user authenticating unit for authenticating a user by referring to an open key certificate for user authentication. The certificate is transmitted from user equipment and dedicated to the user concerned. The system further includes an electronic watermark processing unit for inserting an electronic watermark into a content in which no electronic watermark has been inserted, and a transmission unit for transmitting contents. The system also includes a check server including a first content distributing server authentication unit for authenticating a content distributing server by referring to an open key certificate for content distributing server authentication, and a content checking unit for checking contents stored in the content distributing server and an authentication organization server including an open key certificate supplying unit for issuing the open key certificate for user authentication and the open key certificate for content distributing server authentication and a rescinded certificate list in which only rescinded open key certificates out of the open key certificates for user authentication and content distributing server authentication are described, and a rescission list renewing unit for renewing the rescinded certificate list on the basis of a notification from the check server. The system further includes user equipment including a second content distributing server authenticating unit for authenticating a content distributing server by referring to the open key certificate for content distributing server authentication, a content decoding unit for decoding a content downloaded from the content distributing server, and a content reproducing unit for reproducing the content after the content is processed by the content decoding unit.

According to an embodiment of the present invention, at least one content distributing server, the authentication organization server which issues the open key certificates needed for thee authentication of the content distributing server and the authentication of at least one user and which also issues/renews the rescinded certificate list to certify validity of the open key certificates, and the check server which authenticates the content distributing server and checks contents having electronic watermarks inserted therein which are accumulated and stocked by the content distributing server, if any unjustness is determined, it is requested to the authentication organization server to invalidate the open key certificate which is needed to authenticate the user concerned and held in the content distributing server for which the unjustness is determined. At least one content distributing server, the authentication organization server and the check server are connected to one another through a special-purpose communication line. Each user equipment transmits the open key certificate to a content distributing server on the Internet network for authentication, and downloads a content having an electronic watermark inserted therein which is owned by the content distributing server, subjects the content to the decoding processing and then reproduce the content data, so that comprehensive content protection can be performed.

Additional features and advantages of the present invention are described in, and will be apparent from, the following Detailed Description of the Invention and the figures.

### BRIEF DESCRIPTION OF THE FIGURES

FIG. 1 is a block diagram showing the overall construction of a content protection system according to a first embodiment of the present invention.

FIG. 2 is a block diagram showing the detailed construction of the content distributing server of the content protection system according to the first embodiment of the present invention.

FIG. 3 is a block diagram showing the detailed construction of a check server and an authentication organization server of the content protection system according to the first embodiment of the present invention.

FIG. 4 is a block diagram showing the detailed construction of user equipment of the content protection system according to the first embodiment of the present invention.

FIG. 5 is a diagram showing the operation procedure of the content protection system according to the first embodiment of the present invention.

FIG. 6 is a block diagram showing the overall construction of a content protection system according to a second embodiment of the present invention.

FIG. 7 is a diagram showing the operation procedure of the content protection system according to the second embodiment of the present invention.

### DETAILED DESCRIPTION OF THE INVENTION

First Embodiment

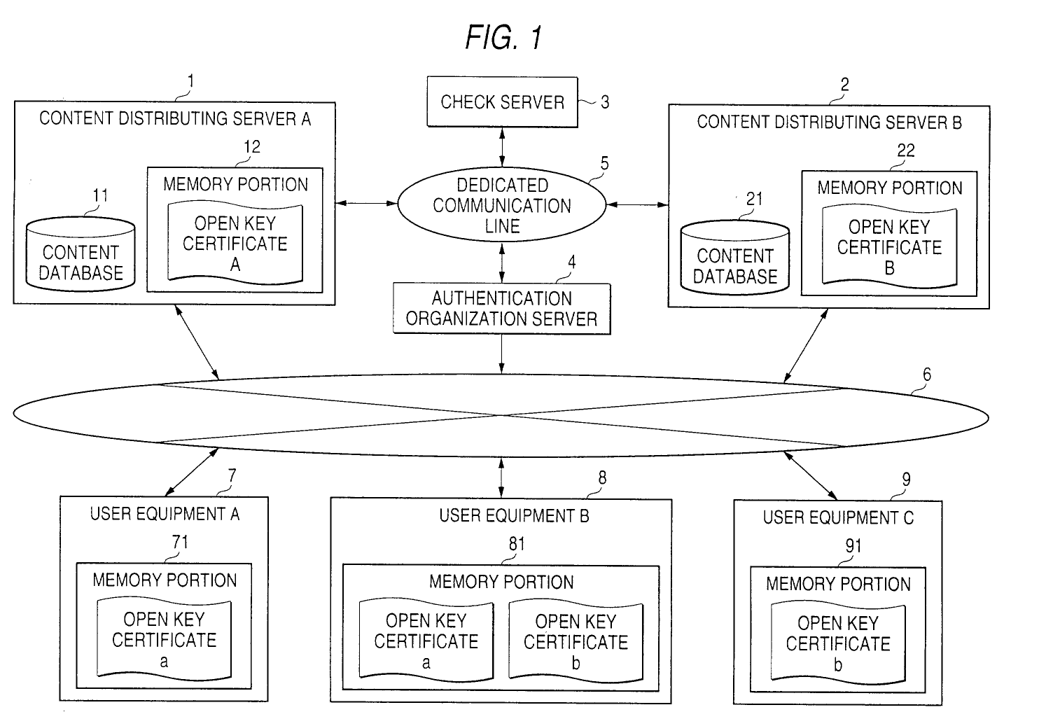

FIG. 1 is a block diagram showing the overall construction of a content protection system according to a first embodiment of the present invention.

The content protection system according to this embodiment includes a content distributing server A 1 and a content distributing server B 2 for distributing contents to user equipment (described below) through an Internet network 6, a check server 3 for checking whether regulated electronic watermarks are inserted in the contents distributed by the content distributing server A 1 and the content distributing server B 2, an authentication organization server 4 for issuing open keys when authentication of the content distributing server A 1 and the content distributing server B 2 is performed by the check server 3 and authentication of users is performed by the content distributing server A 1 and the content distributing server B 2. The system further includes a dedicated communication line 5 for connecting the content distributing server A 1, the content distributing server B 2, the check server 3 and the authentication organization server 4 to one another so that these servers can communicate with one another, the Internet network 6 for connecting the content distributing server A 1 and the content distributing server B 2 with user equipment described later so that they can communicate with one another, and user equipment A 7 (having content reproducing ability), user equipment B 8 and user equipment C 9 which download through the Internet network 6 the contents distributed by the content distributing server A 1 or the content distributing server B 2 and reproduce the contents thus downloaded.

Here, the dedicated communication line 5 may contain the Internet network 6 in the route thereof or it may be substituted by the Internet network 6. Further, an electronic watermark inserted in a content may be independently inserted by each content distributing server or it may be independently inserted by an original content server which supplies an original content to a content distributing server to request distribution of the content.

Here, the user equipment A 7 holds only an open key certificate a paired with the open key certificate A transmitted from the authentication organization server 4 to the content distributing server A 1, while the user equipment B 8 holds both the open key certificate a paired with the open key certificate A transmitted from the authentication organization server 4 to the content distributing server A 1 and an open key certificate b paired with the open key certificate B transmitted from the authentication organization server 4 to the content distributing server B 2. The user equipment C 9 holds only the open key certificate b paired with the open key certificate B transmitted from the authentication organization server 4 to the content distributing server B 1. These open key certificates are transmitted from the authentication organization server 4 to each user equipment and then installed in each user equipment in advance.

In general, user equipment other than the user equipment A 7, the user equipment B 8 and the user equipment C 9 shown in FIG. 1 may be used. In addition, PKI (Public Key Infrastructure) containing an electronic signature (e.g., a digital signature) may be used as an authenticating system.

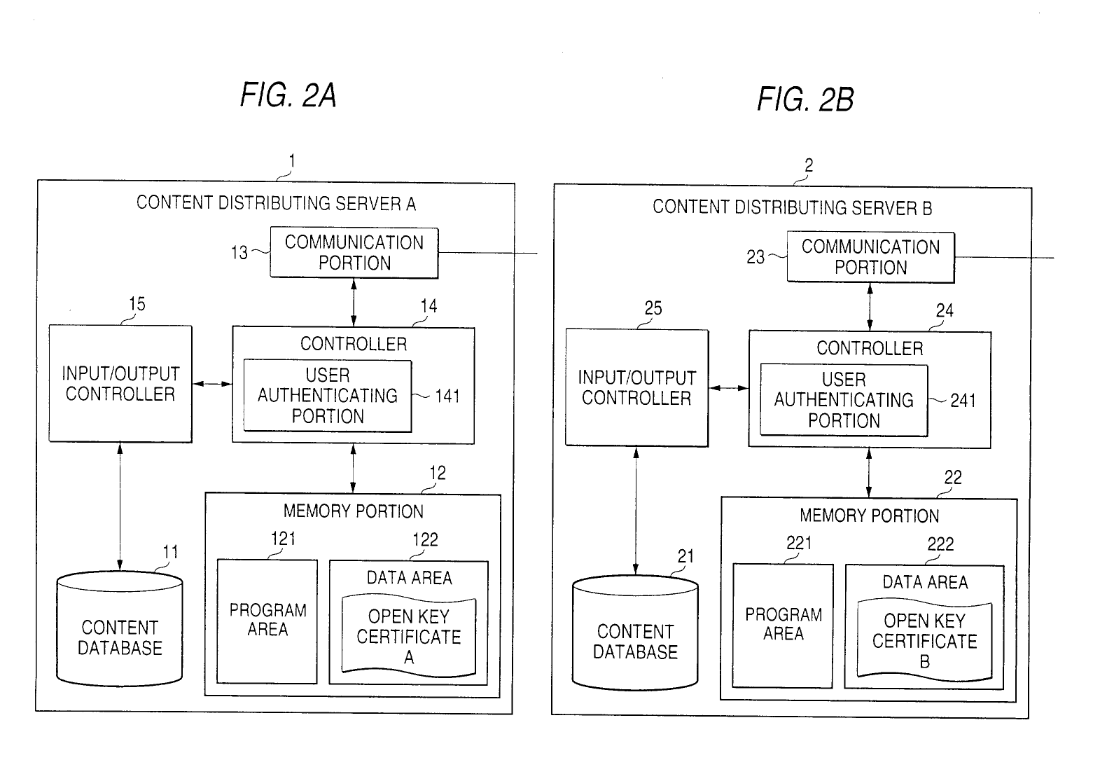

The content distributing server A 1 is equipped with a content database 11 in which contents to be distributed are stocked or stored, and a storage portion 12 for storing the open key certificate A. The constituent elements of the detailed construction of the content distributing server A 1 will be described later with reference to FIG. 2A.

The content distributing server B 2 is equipped with a content database 21 in which contents to be distributed are stocked, and a storage portion 22 for storing the open key certificate B. The constituent elements of the detailed construction of the content distributing server B 2 will be described later with reference to FIG. 2B.

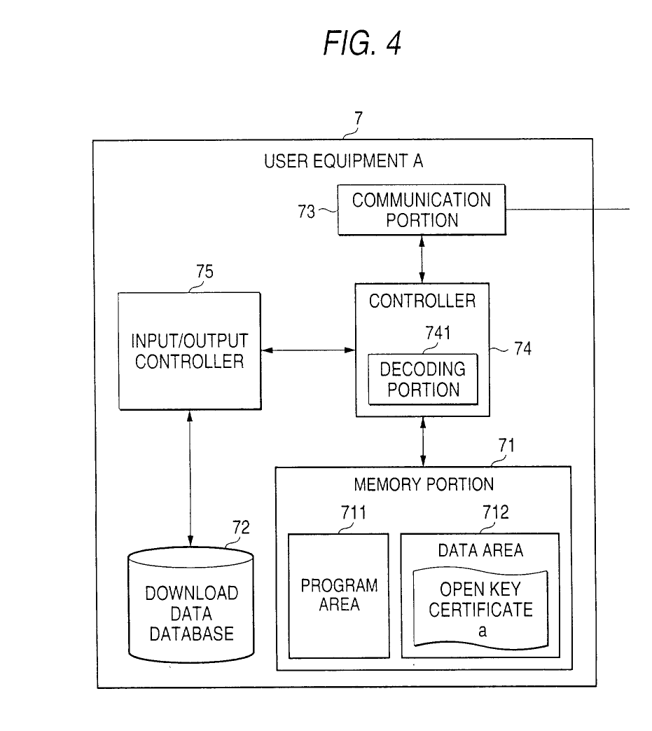

Further, the user equipment A 7 includes a storage portion 71 containing the open key certificate a paired with the open key certificate A, while the user equipment B 8 includes a storage portion 81 containing the open key certificate A and the open key certificate b paired with the open key certificate B. The user equipment C 9 further includes a storage portion 91 containing the open key certificate b. The constituent elements of the detailed construction of the user equipment will be described later with reference to FIG. 4.

FIGS. 2A and 2B are block diagrams showing the detailed construction of the content distributing server of the content protection system according to the first embodiment of the present invention. FIG. 2A shows the detailed construction of the content distributing server A 1 shown in FIG. 1, and FIG. 2B shows the detailed construction of the content distributing server B 2 shown in FIG. 1.

In addition to the content database 11 and the storage portion 12 shown in FIG. 1, the detailed construction of the content distributing server A 1 shown in FIG. 2A is further equipped with a communication portion 13 for connecting the dedicated communication line 5 and the Internet network 6 so that they can communicate with each other, a controller 14 that performs the overall control and functions as a user authenticating portion 141 using the open key certificate A, an electronic watermark processor for inserting an electronic watermark into a content in which any electronic watermark has not yet been inserted and content transmitter, and an input/output controller 15 for controlling the content database 11.

The detailed construction of the storage portion 12 includes a data area 122 for storing the open key certificate A shown in FIG. 1, and a program area 121 in which a program started and executed by the controller 14 is stored.

In addition to the content database 21 and the storage portion 22 shown in FIG. 1, the detailed construction of the content distributing server B 2 shown in FIG. 2B includes a communicating portion 23 for connecting the dedicated communication line 5 and the Internet network 6 so that they can communicate with each other, a controller 24 which performs the overall control and functions as a user authenticating portion 241 using the open key certificate B, a processor of an electronic watermark to be inserted into a content and a content transmitter, and an input/output controller 25 for controlling the content database 21.

The detailed construction of the storage portion 22 includes a data area 222 in which the open key certificate B shown in FIG. 1 is stored, and a program area 221 in which a program started and executed by the controller 24 is stored.

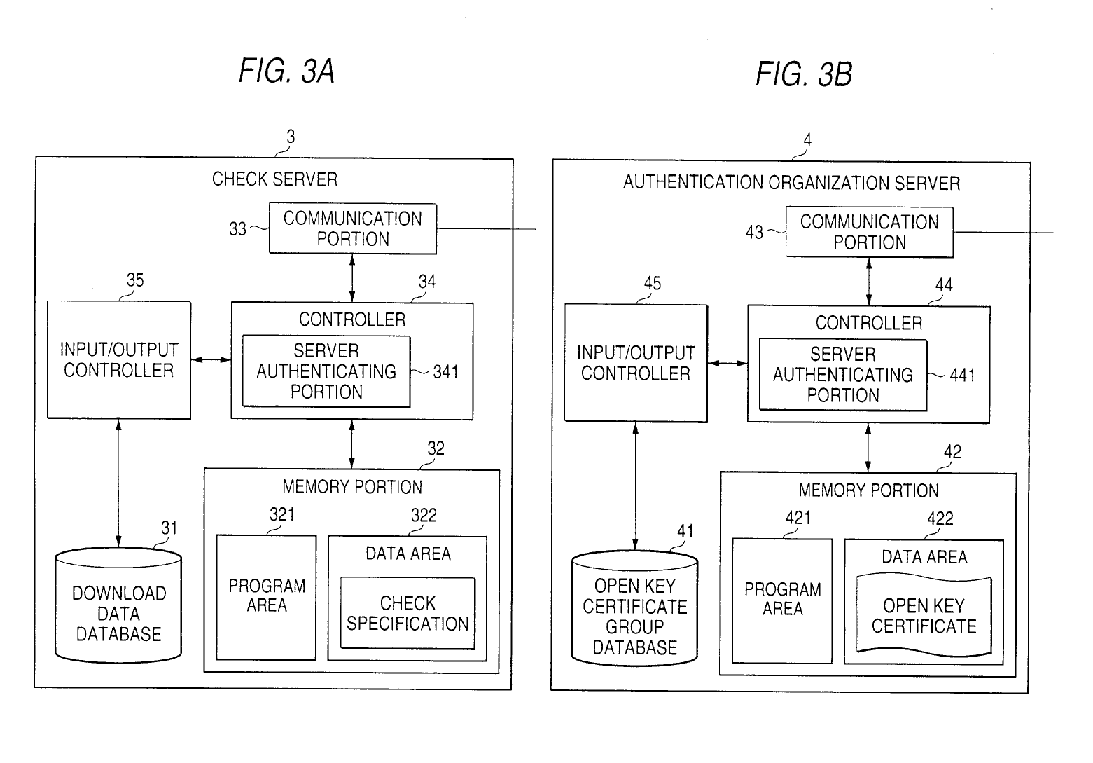

FIG. 3A and 3B are block diagrams showing the detailed construction of the check server and the authentication organization server of the content protecting system according to the first embodiment of the present invention. FIG. 3A shows the detailed construction of the check server 3 shown in FIG. 1, and FIG. 3B shows the detailed construction of the authentication organization server 4 shown in FIG. 1.

The detailed construction of the check server 3 shown in FIG. 3A includes a storage portion 32 (described later), a communication portion 33 which is communicatively connected to the dedicated communication line 5, a controller 34 which performs the overall control, functions as a content distributing server authenticating unit and check unit for contents having electronic watermarks, and contains a server authentication portion 341, a download data database 31 for storing contents having electronic watermarks downloaded from the content distributing server A 1 and the content distributing server B 2 for check, and an input/output controller 35 for controlling the download database 31.

The detailed construction of the storage portion 32 includes a data area 322 for storing a check specification to check contents having electronic watermarks and open key certificates (not shown) used to authenticate the content distributing server A 1 and the content distributing server B 2, and a program area 321 in which a program started and executed by the controller 34 is stored.

The detailed construction of the authentication organization server 4 shown in FIG. 3B includes a storage portion 42 (described later), a communication portion 43 for connecting the dedicated communication line 5 and the Internet network 6 so that they can communicate with each other, a controller 44 that performs the overall control, functions as authenticating unit of the content distributing server A 1 and the content distributing server B 2, open key certificate supplier, rescission list issuing unit and rescission list renewing unit and contains a server authenticating portion 441, an open key certificate group DB 41 for storing an open key certificate group including a number of open key certificates to certify the content distributing server A 1, the content distributing server B 2 and the user equipment A 7 to the user equipment C 9, and an input/output controller 45 for controlling the open key certificate group DB 41.

The detailed construction of the storage portion 42 includes a data area 422 for storing an open key certificate which is read out from the open key certificate group database 41 and delivered to any one of the content distributing server A 1, the content distributing server B 2 and the user equipment A 7 to the user equipment C 9, and a program area 421 for storing a program started and executed by the controller 44.

FIG. 4 is a block diagram showing the detailed construction of the user equipment of the content protection system according to the first embodiment of the present invention. FIG. 4 shows the detailed construction of the user equipment A 7 shown in FIG. 1. The other user equipment shown in FIG. 1 is the same as the detailed construction of the user equipment A 7.

In addition to the storage portion 71 shown in FIG. 1, the detailed construction of the user equipment A 7 shown in FIG. 4 includes a communication portion 73 which is communicatively connected to the Internet work 6, a controller 74 which performs the overall control, functions as an authenticating unit for the content distributing server A 1 and the content distributing server B 2 and a content decoder for removing an electronic watermark inserted into a content after the content is decoded, if necessary and contains a decoding portion 741, a download data database 72 for storing contents having electronic watermarks downloaded from the content distributing server A 1 or the content distributing server B 2 for use (reproduction) of the contents, and an input/output controller 75 for controlling the download data DB 72. The portion functioning as the content reproducing unit is omitted from the illustration.

The detailed construction of the storage portion 71 includes a data area 712 for storing the open key certificate a shown in FIG. 1, and a program area 711 in which a program started and executed by the controller 74 is stored.

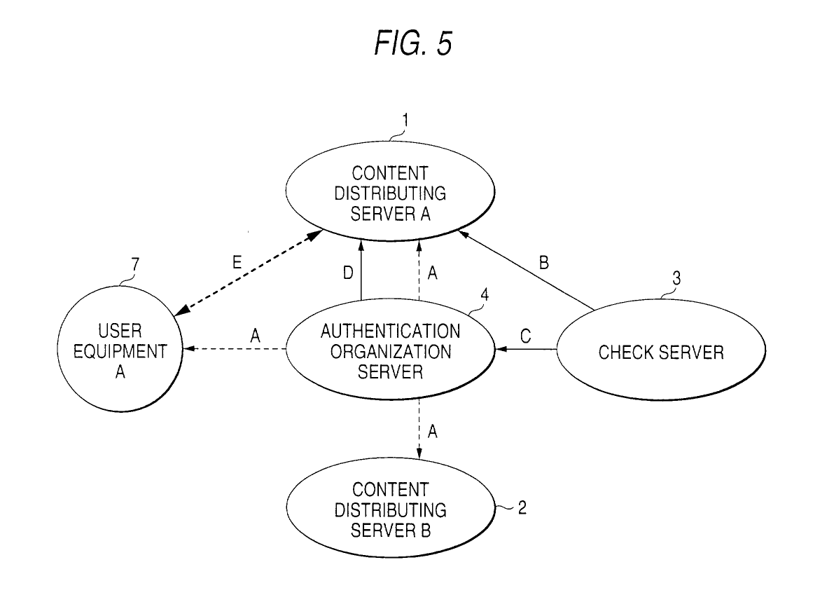

FIG. 5 is a diagram showing the operation procedure of the content protection system according to the first embodiment of the present invention. The operating procedure of the content protecting system according to this embodiment shown in FIG. 5 will be described with reference to FIGS. 1 to 4.

First, in an operation step A, the authentication organization server 4 transmits a user authenticating open key certificate to the content distributing server A 1 and the content distributing server B 2, and also transmits to the check server 3 and the user equipment A 7 dedicated open key certificates for content distributing server authentication which are discriminated between the content distributing server A 1 and the content distributing server B 2. At this time, a rescission list of open key certificates is also issued by an issuing unit for the rescission list. As these open key certificates for content distributing server authentication may be used the open key certificates for content distributing server authentication which are provided at the entrance registration time of member servers (in this case, the content distributing server A 1 and the content distributing server B 2).

In an operation step B, the check server 3 authenticates the content distributing server A 1 at regular or irregular intervals and then refers to the contents stored in the content distributing server A 1to check whether these contents comply with the contract or law. The checking method may be a check method using another route which is not along the content flow route between the content distributing server A 1 and the user equipment A 7 or may be a check method which is along the content flow route (in this case, user equipment under check may be mounted in the check server 3).

In an operation step C, when unjustness of a content stored in the content distributing server A 1 is detected through the check of the operation step B, the check server 3 notifies the authentication organization server 4 of this fact and requests the invalidation of the open key certificate A used by the content distributing server A 1.

In an operation step D, the authentication organization server 4 invalidates the open key certificate A used by the content distributing server A 1, and transmits a notification indicating this rescission to the content distributing server A 1. At this time, the authentication organization server 4 renews a CRL (Certificate Rescission List) if necessary through a renewing unit for the rescission list.

In an operation step E, the user equipment A 7 transmits the open key certificate a to the content distributing server A 1 for authentication and tries to download a content from the content distributing server A 1. However, if any unjustness is detected in the content stored in the content distributing server A 1 through the check of the operation step B, the content distributing server A 1 refers to the CRL or the like issued by the authentication organization server 4 to recognize that the open key certificate A corresponding to the open key certificate a has been rescinded. Therefore, the user equipment A 7 is not authenticated, and a notification that authentication of the user equipment A 7 has failed carried out from the content distributing server A 1, so that user equipment 7 disconnects the connection to the content distributing server A 1, and an unjust content can be prevented from being used by the user.

When no unjustness is detected in the contents stocked in the content distributing server A 1 through the check of the operation step B, the content distributing server A 1 refers to the CRL or the like issued by the authentication organization server 4 to recognize that the open key certificate A is valid. Therefore, the user equipment A 7 is authenticated, and the download of a content from the content distributing server A 1 to the user equipment A 7 by the content transmitter succeeds. The content thus downloaded is decoded in the decoding portion 741 of the user equipment A 7, and if necessary, an electronic watermark, inserted in the content, is removed and reproduced by the content reproducing unit.

FIG. 5 shows the case where the check server 3 checks the content distributing server A 1, and the same is applied to the check of the content distributing server B 2.

Second Embodiment

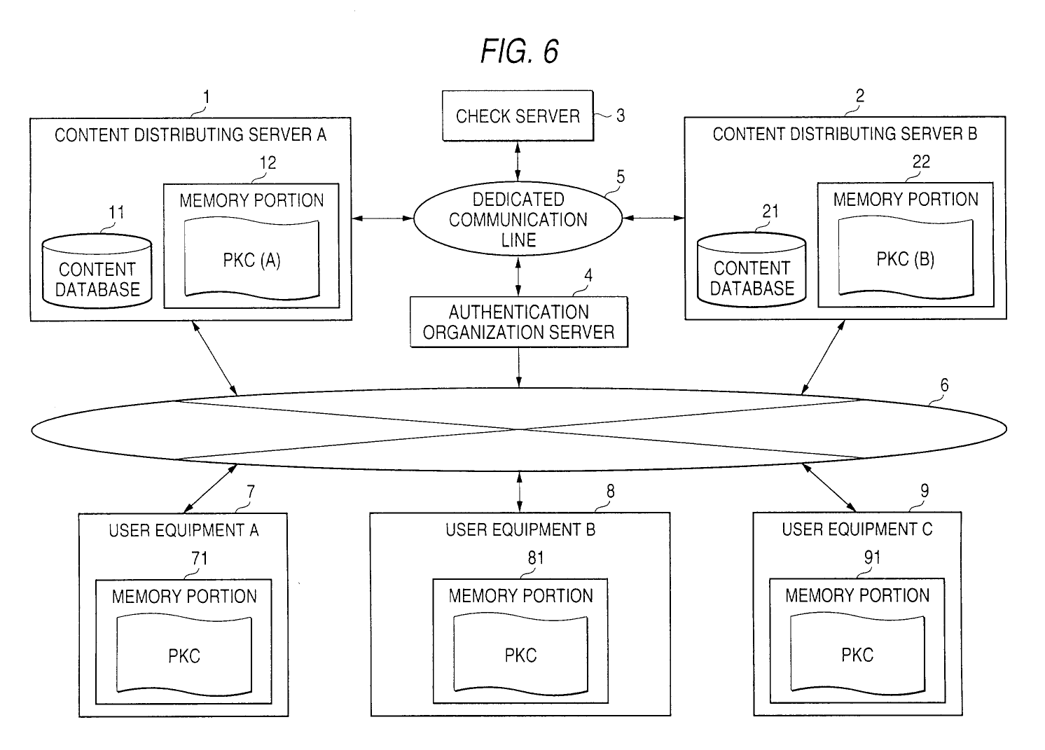

FIG. 6 is a block diagram showing the overall construction of a content protection system according to a second embodiment of the present invention.

The overall construction of the content protection system according to this embodiment is similar to the overall construction of the content protection system according to the first embodiment of the present invention shown in FIG. 1, and the detailed construction of the constituent elements thereof is similar to the detailed construction shown in FIGS. 2 to 4. However, the second embodiment is different from the first embodiment in that each of the user equipment A 7, the user equipment B 8 and the user equipment C 9 supports both of two open keys (represented by PKC (A) and PKC (B)) and thus holds a common open key certificate (represented by PKC) which can pass an authentication executed by each of the content distributing server A 1 and the content distributing server B 2.

This common open key certificate is also transmitted from the authentication organization server 4to each user equipment in advance, and then installed in each user equipment.

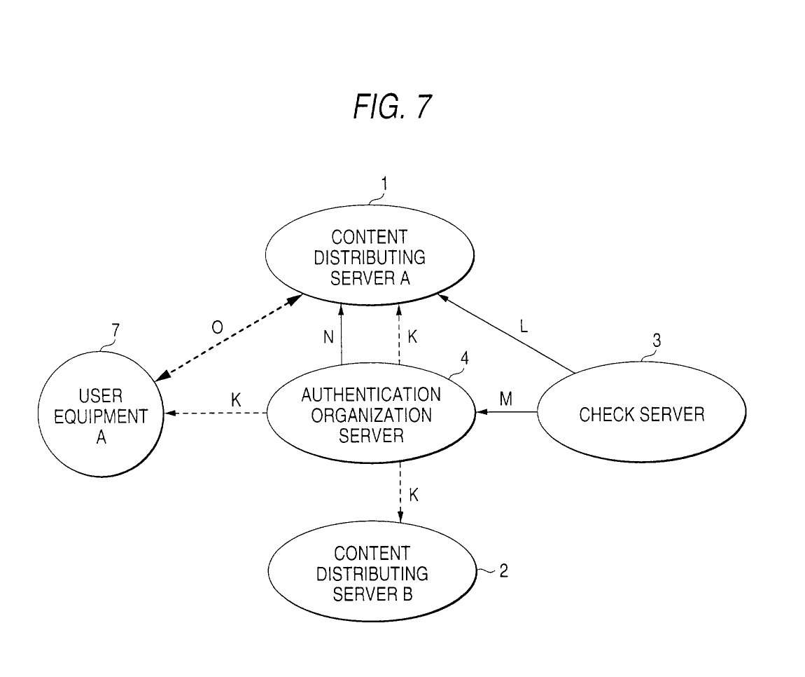

FIG. 7 is a diagram showing the operation procedure of the content protecting system according to the second embodiment of the present invention. The operation procedure of the content protecting system according the embodiment shown in FIG. 7 will be described with reference to FIGS. 1 to 4.

First, in an operation step K, the authentication organization server 4 transmits a user authenticating open key certificate to each of the content distributing server A 1 and the content distributing server B 2, and also transmits to each of the check server 3 and the user equipment A 7 a common content distributing server authenticating open key certificate with which the content distributing server A 1 and the content distributing server B 2 can be commonly authenticated. At this time, a rescission list of open key certificates is also issued by an issuing unit of the rescission list. As this open key certificate for content distributing server authentication may be used an open key certificate for content distributing server authentication which is provided at the entrance registration time of a member server (in this case, the content distributing server A 1 and the content distributing server B 2).

In an operation step L, the check server 3 regularly or irregularly authenticates the content distributing server A 1 and then refers to the contents stocked in the content distributing server A 1 to check whether these contents comply with the contract or law. The checking method may be a check method using another route which is not along the content flow route between the content distributing server A 1 and the user equipment A 7 or may be a check method which is along the content flow route (in this case, user equipment under check may be mounted in the check server 3).

In an operation step M, when unjustness of a content stored in the content distributing server A 1 is detected through the check of the operation step L, the check server 3 notifies the authentication organization server 4 of this fact and requests the invalidation of open key certificate A used by the content distributing server A 1.

In an operation step N, the authentication organization server 4 invalidates the open key certificate A used by the content distributing server A 1,and transmits a notification indicating this rescission to the content distributing server A 1. At this time, the authentication organization server 4 renews a CRL (Certificate Rescission List) if necessary through the renewing unit for the rescission list.

In an operation step 0, the user equipment A 7 transmits PKC to the content distributing server A 1 for authentication and tries to download a content from the content distributing server A 1, if unjustness is detected in the content stocked in the content distributing server A 1 through the check of the operation step L, by referring to the CRL or the like issued by the authentication organization server 4, the content distributing server A 1 recognizes that the PKC open key certificate A corresponding to the above PKC has been rescinded. Therefore, the user equipment A 7 is not authenticated, and this failure of authentication is notified from the content distributing server A 1 to the user equipment A 7, whereby the user equipment A 7 disconnects the connection with the content distributing server A 1 and thus the unjust content can be prevented from being used by users. At this time, the PKC open key certificate B corresponding to the above PKC has not yet been rescinded, and thus the user equipment A 7 can download the contents stocked in the content distributing server B 2.

Further, if no unjustness is detected in the contents stocked in the content distributing server A 1 through the check of the operation step L, by referring to the CRL or the like issued by the authentication organization server4,the content distributing server A 1 recognizes that the open key certificate A is valid. Therefore, the user equipment A 7 is authenticated and the download of a content from the content distributing server A 1 to the user equipment A 7 by the content transmitter succeeds. The content thus downloaded is decoded in the decoding portion 741 of the user equipment A 7, and if necessary, the electronic watermark inserted in the content is removed and reproduced by the content reproducing unit.

FIG. 7 shows the case where the check server 3 checks the content distributing server A 1, and the same is applied to the content distributing server B 2.

As described above, according to the present invention, one or more content distributing servers, an authentication organization server for issuing open key certificates needed to authenticate the content distributing servers and one or more users and issuing/renewing a certificate rescission list for certifying validity of the open key certificates, and a check server for authenticating the content distributing servers, checking contents having electronic watermarks inserted therein which are accumulated and stocked in the content distributing servers, and requesting the authentication organization server to rescind an open key certificate needed for user authentication which is held in the content distributing server and for which unjustness is detected, are connected to one another through a dedicated communication line. Each of one or more user equipment transmits an open key certificate to a content distributing server on the Internet network for authentication, downloads a content containing an electronic watermark owned by the content distributing server, decodes the content thus downloaded and then reproduce the decoded content. Therefore, the comprehensive content protection can be performed.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. A content protection system for content distributing servers for accumulating contents to be transmitted in response to requests for use, comprising:
at least one content distributing server including a user equipment authenticator for referring to an open key certificate of user equipment making a request for use to authenticate the user equipment, an electronic watermark processor for inserting electronic watermarks into the contents, and a transmitter for transmitting the contents;
a check server including a first content distributing server authenticator for authenticating the content distributing server based on an open key certificate for authenticating the content distributing server, and determination unit for checking the contents held in said content distributing server;
an authentication organization server including an issuing unit for issuing the open key certificate for authenticating the user equipment and the open key certificate for authenticating the content distributing server, and a rescission list indicating rescinded open key certificates, and a renewing unit for renewing the rescission list on the basis of a notification from the check server; and
at least one user equipment including a second content distributing server authenticator for referring to an open key certificate for authenticating the content distributing server to authenticate the content distributing server, and an executor for executing content received from the content distributing server.

2. A content protection system as claimed in claim 1, wherein the open key certificate is an open key certificate for authentication that is commonly used by content distributing servers.

3. A content protection system as claimed in claim 1, wherein the executor equipped to the user equipment removes an electronic watermark from the content.

4. A content protection system, comprising:
a check server including a first content distributing server authenticator for authenticating a content distributing server based on an open key certificate for authenticating the content distributing server which transmits content to be distributed in response to a request from user equipment, and determination unit for checking contents held in the content distributing server; and
an authentication organization server including a rescission list issuing unit for issuing a rescission list that specifies rescinded open key certificates out of the open key certificates for authenticating the user equipment and the content distributing server, and a renewing unit for renewing a rescission list in response to an addition request
of rescinded open key certificates into the rescission list from the check server, wherein the authentication of the content distributing server is carried out by referring to the open key certificate for authenticating the content distributing server, and the user equipment is allowed to reproduce the content.

5. A content protection method for content distributing servers for accumulating contents to be transmitted in response to requests for use, the method comprising the steps of:
referring to an open key certificate of user equipment making a request for use to authenticate the user equipment;
inserting electronic watermarks into the contents;
transmitting the contents;
authenticating the content distributing server based on an open key certificate for authenticating the content distributing server;
checking the contents held in the content distributing server;
issuing the open key certificate for authenticating the user equipment and the open key certificate for authenticating the content distributing server, and a rescission list indicating rescinded open key certificates;
renewing the rescission list;
referring to an open key certificate for authenticating the content distributing server to authenticate the content distributing server; and
executing content received from the content distributing server in the user equipment.

6. A content protection method, the method comprising the steps of:
authenticating a content distributing server based on an open key certificate for authenticating the content distributing server which transmits a content to be distributed in response to a request for use;
checking contents held in the content distributing server;
issuing a rescission list that specifies rescinded open key certificates out of the open key certificates for authenticating the user equipment and the content distributing server; and
renewing a rescission list in response to an addition request of rescinded open key certificates into the rescission list from a check server, wherein the authentication of the content distributing server is carried out by referring to the open key certificate for authenticating the content distributing server, and the user equipment is allowed to reproduce the content.
